(19) United States
(12) Patent Application Publication
(10) Pub. No.: US 2025/0132932 A1
(43) Pub. Date: Apr. 24, 2025

(54) CERTIFICATE MANAGEMENT AS-A-SERVICE FOR SOFTWARE-DEFINED DATACENTERS

(71) Applicant: VMware LLC, Palo Alto, CA (US)

(72) Inventors: Kundan Sinha, Bangalore (IN); Shalini Krishna, Bangalore (IN)

(21) Appl. No.: 18/649,936

(22) Filed: Apr. 29, 2024

(30) Foreign Application Priority Data
Oct. 18, 2023 (IN) 202341070992

(51) Int. Cl. H04L 9/32

(52) U.S. Cl. CPC H04L 9/3268

(57) ABSTRACT

Certificate management as-a-service for software-defined datacenters is described herein. One method includes receiving an indication of an expiry of a first certificate of a virtual appliance in a virtualized environment via a certificate management agent of a gateway device in communication with the appliance, and performing a certificate replacement process responsive to determining that the expiry of the first certificate exceeds a threshold, wherein the certificate generation process includes sending a request to the appliance via an agent associated with the appliance, receiving, from the appliance, a certificate signing request (CSR), sending the CSR to an external certificate authority, receiving a second certificate from the certificate authority, and replacing the first certificate with the second certificate.

### RELATED APPLICATIONS

This application claims priority to Indian Application Serial No. 202341070992 filed Oct. 18, 2023, by VMware LLC, entitled “CERTIFICATE MANAGEMENT AS-A-SERVICE FOR SOFTWAREDEFINED DATACENTERS,” which is hereby incorporated by reference in its entirety for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for certificate management as-a-service for software-defined datacenters according to one or more embodiments of the present disclosure.

FIG. 2 is a system associated with certificate management as-a-service for software-defined datacenters according to one or more embodiments of the present disclosure.

FIG. 3 is a flow chart associated with certificate management as-a-service for software-defined datacenters according to one or more embodiments of the present disclosure.

FIG. 4 illustrates a system for certificate management as-a-service for software-defined datacenters according to one or more embodiments of the present disclosure.

FIG. 5 is a diagram of a machine for certificate management as-a-service for software-defined datacenters according to one or more embodiments of the present disclosure.

### DETAILED DESCRIPTION

The term “virtual computing instance” (VCI) covers a range of computing functionality, such as virtual machines, virtual workloads, data compute nodes, clusters, and containers, among others. A virtual machine refers generally to an isolated user space instance, which can be executed within a virtualized environment. Other technologies aside from hardware virtualization can provide isolated user space instances, also referred to as data compute nodes, such as containers that run on top of a host operating system without a hypervisor or separate operating system and/or hypervisor kernel network interface modules, among others. Hypervisor kernel network interface modules are data compute nodes that include a network stack with a hypervisor kernel network interface and receive/transmit threads. The term “VCI” covers these examples and combinations of different types of data compute nodes, among others.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs. While the present disclosure refers to VCIs, the examples given could be any type of virtual object, including data compute node, including physical hosts, VCIs, non-VCI containers, virtual disks, and hypervisor kernel network interface modules. Embodiments of the present disclosure can include combinations of different types of data compute nodes.

VCIs can be created in a public cloud environment. The term public cloud refers to computing services (hereinafter referred to simply as “services”) provided publicly over the Internet by a cloud service provider. One example of a cloud service provider is Amazon Web Services (AWS), though embodiments of the present disclosure are not so limited. A public cloud frond end refers to the user-facing part of the cloud computing architecture, such as software, user interface, and client-side devices. A public cloud backend refers to components of the cloud computing system, such as hardware, storage, management, etc., that allow the front end to function as desired. Some public cloud backends allow customers to rent VCIs on which to run their applications. Users can boot a VCI base image to configure VCIs therefrom. Users can create, launch, and terminate such VCIs as needed. Users can be charged, for example, for the time during which the VCI is in operation.

Certificate management, which is an important piece for enterprise security, is also one of the most tedious and time-consuming tasks any network cloud or datacenter administrator performs. It involves a series of steps that need specialized skills in managing public key infrastructure (PKI) of an organization. In some infrastructures, for instance, it has been observed that data center administrators may forget to renew and replace certificates (despite multiple alerts) on time, leading to certificate expiration and thereby the entire infrastructure becoming inaccessible. The problem becomes compounded when there are multiple different products in the virtualized environment, each having its own certificate management system. To avoid this, embodiments of the present disclosure provide a uniform and automated solution for certificate management in the entire infrastructure.

Various technologies used by previous approaches are available for automatic certificate renewal in the market like Certificate Management Protocol (e.g., CMPv2), Simple Certificate Enrollment Protocol (SCEP), Automatic Certificate Management Environment (ACME), etc. These technologies are used in web applications or web servers to automatically renew and replace a certificate before it expires in an automated way. These technologies are very popular and almost all web servers support them. For these protocols to function, the web services need to have direct access to the internet and the certificate issuing Certificate Authority (CA), so they can contact the CA to renew the certificate(s).

However, in some virtualized environments, technologies like CMPv2, SCEP, and/or ACME are not feasible. The examples of vCenter and other VMware related infrastructure softwares like NSX, SDDC manager for VCF, vRA, and vROPS are typically deployed inside a data center behind a firewall without any external access. Since vCenter or these infrastructure softwares cannot make a connection to any external well-known commercial certificate authority, it cannot request for renewal of the certificates using the above technologies. Giving all the infrastructure software access to the internet would meant opening so many ports within the infrastructure, making it more vulnerable to cyber-attacks.

Some virtualization platforms (e.g., vSphere) are being offered as cloud-connected subscription services. Embodiments of the present disclosure include creating a cloud service in the virtualization platform that can not only manage the certificates of the connected server (e.g., vCenter server), but can manage the certificate of every virtual appliance that can connect to the cloud. Stated differently, embodiments herein can create a cloud service that is capable of managing the certificate of any virtual appliance connected to the cloud.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

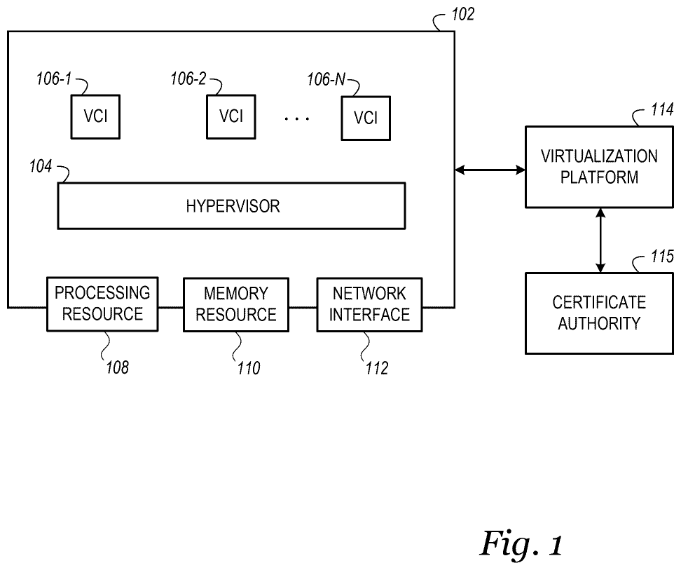

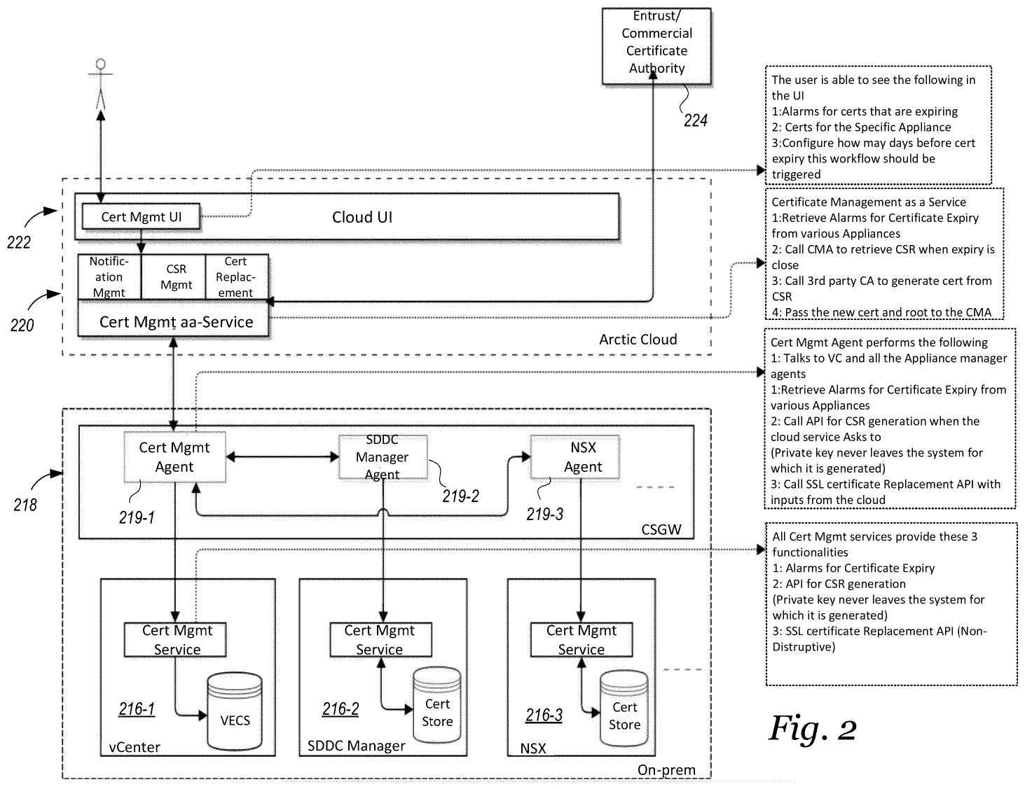

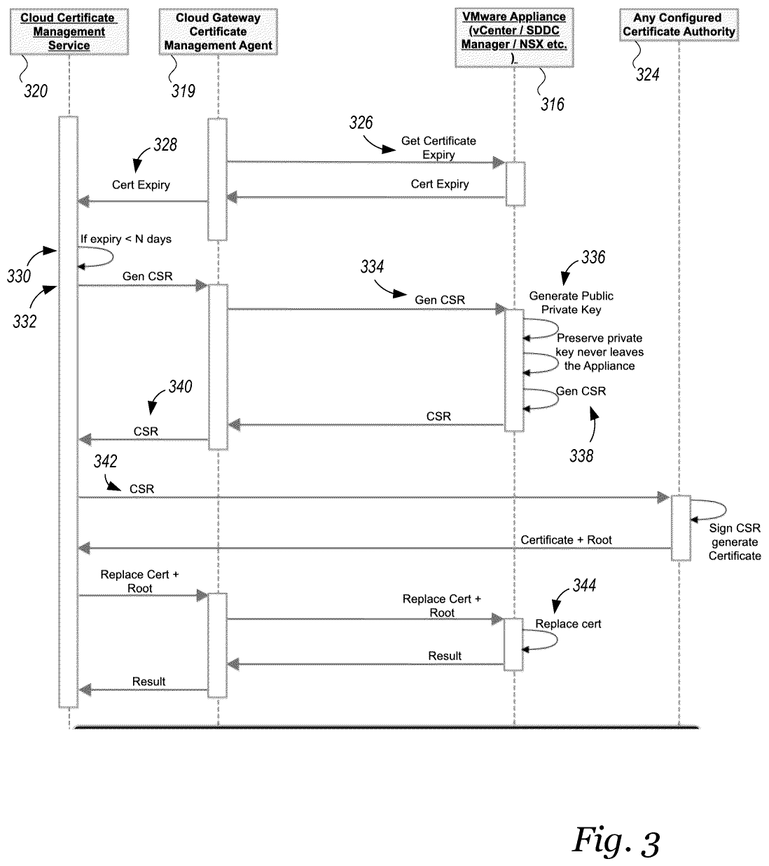

The figures herein follow a numbering convention in which the first digit or digits correspond to the drawing figure number and the remaining digits identify an element or component in the drawing. Similar elements or components between different figures may be identified by the use of similar digits. For example, 219 may reference element “19” in FIG. 2, and a similar element may be referenced as 319in FIG. 3. Analogous elements within a Figure may be referenced with a hyphen and extra numeral or letter. Such analogous elements may be generally referenced without the hyphen and extra numeral or letter. For example, elements 116-1, 116-2, and 116-N in FIG. 1A may be collectively referenced as 116. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for object validation in SDDC scripts according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a virtualization platform 114. The virtualization platform 114 can be in communication with a certificate authority 115. The certificate authority can be a third-party commercial certificate authority, as known to those of skill in the art, for instance.

FIG. 2 is a system associated with certificate management as-a-service for software-defined datacenters according to one or more embodiments of the present disclosure. The system can comprise a stack, the bottom on which includes various virtual appliances. In the example illustrated in FIG. 2, a first appliance 216-1 is vCenter, a second appliance 216-2 is SDDC manager, and a third appliance 216-3 is NSX, though embodiments herein are not so limited. These appliances can expose three application programming interfaces (APIs) for particular operations. A first operation can be an event for certificate expiry and an API for fetching the certificate API. A second operation can be the generation of a certificate signing request (CSR) for the appliance. A third operation can be the replacement of the existing secure sockets layer (SSL) certificate on the appliance with a new certificate.

In the middle of the stack illustrated in the system of FIG. 2 is a gateway (e.g., the cloud service gateway (CSGW)) 218. The gateway 218 is the entry point to the cloud service for certificate management. The gateway 208 can host the agents that connect to their respective appliance flavors (e.g., VC, SDDS manager, NSX, etc.). Three example agents are illustrated in FIG. 2, a certificate management agent (CMA) 219-1, an SDDC manager agent 219-2, and an NSX agent 219-3, though it is noted that embodiments of the present disclosure are not so limited. These agents 219 call the APIs for gathering certificate expiry, generate CSR for the appliance, and replace the certificate on their respective appliances. The gateway 218 has a special agent, the CMA 219-1, that collects this information and passes it to the cloud service, which is deployed in the cloud (e.g., the Arctic cloud). The CMA 219-1 can also act as the agent to renew and replace the certificate of the gateway 218 because the gateway 218 itself can be treated as an appliance. Because the CMA 219-1 is also closely linked with vCenter 216-1, it acts as the agent to call vCenter certificate APIs for expiry, generation of CSR, and/or certificate replacement, as described herein.

At the top layer is the certificate management service (CMS) 220 in the cloud. The CMS 220 can gather information regarding the registered appliance certificate expiry. The CMS 220 can trigger a workflow for certificate replacement if a certificate is to expire within a threshold period of time. The CMS 220 can send a message to the CMA agent 219-1 to contact the respective agent to generate a CSR from the appliance. Once the CSR is received, the CMS 220 can contact the third party certificate authority 224 to get a signed certificate. Once the signed certificate is received, the CMS 220 can call the certificate replacement workflow through CMA 219-1 and the corresponding appliance(s)' agent(s). Users can view the certificate expiry alarms and configure the number of days before expiry that the certificate replacement should be called.

FIG. 3 is a flow chart associated with certificate management as-a-service for software-defined datacenters according to one or more embodiments of the present disclosure. At 326, the agent 319 specific to an appliance 316 monitors the alarm or polls on the API to get the certificate expiry for the SSL certificate of the appliance 316. At 328, the agent 319 sends this information to the cloud 320 via the CMA 319 on the gateway. At 330, the certificate management service 320 checks for the expiry of the certificate. At 332, if the certificate is expiring in less than a threshold amount of time, the certificate management service 320 calls the CMA 319 to initiate the CSR generation process. At 334, this request is sent to the appliance 316 via the appliance-specific agent 319. At 336, the appliance 316 generates a fresh set o the public and private keys using any OpenSSL library and preserves the private key. At 338, using the public key the appliance 316 generates a CSR. At 340, the CSR is sent to the certificate management service 320 on the cloud via the CMA 319 and the appliance-specific agent. The private key does not leave the appliance 316 as it should be held by the appliance 316 for security. At 342, the cloud certificate management service 320 sends the CSR for signing to the third party certificate authority 324. The cloud management service 320 has access to the internet and can contact third parties (e.g., the certificate authority 324). At 344, once the certificate is generated, the certificate management service 320 pushes it to the appliance 316 for certificate replacement.

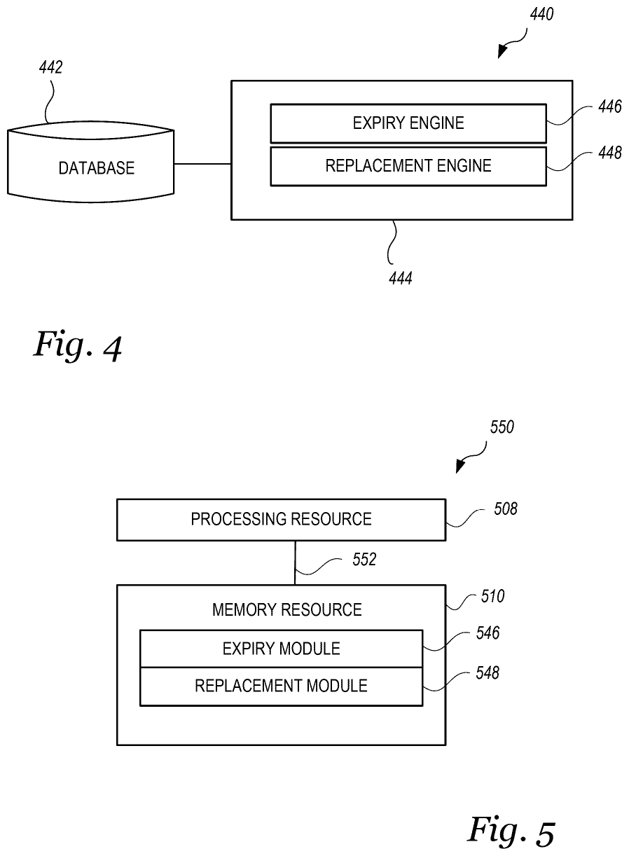

FIG. 4 illustrates a system 440 for certificate management as-a-service for software-defined datacenters according to one or more embodiments of the present disclosure. The system 440 can include a database 442, a subsystem 444, and/or a number of engines, for example expiry engine 446, and/or replacement engine 448, and can be in communication with the database 442 via a communication link. The system 440 can include additional or fewer engines than illustrated to perform the various functions described herein. The system can represent program instructions and/or hardware of a machine (e.g., machine 550 as referenced in FIG. 5, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the expiry engine 446 can include a combination of hardware and program instructions that is configured to receive an indication of an expiry of a first certificate of a virtual appliance in a virtualized environment via a certificate management agent of a gateway device in communication with the appliance. In some embodiments, the replacement engine 448 can include a combination of hardware and program instructions that is configured to perform a certificate replacement process responsive to determining that the expiry of the first certificate exceeds a threshold. As described herein, a certificate replacement process can include sending a request to the appliance via an agent associated with the appliance. As described herein, a certificate replacement process can include receiving, from the appliance, a certificate signing request (CSR). As described herein, a certificate replacement process can include sending the CSR to an external certificate authority. As described herein, a certificate replacement process can include receiving a second certificate from the certificate authority. As described herein, a certificate replacement process can include replacing the first certificate with the second certificate.

FIG. 5 is a diagram of a machine 550 for certificate management as-a-service for software-defined datacenters according to one or more embodiments of the present disclosure. The machine 550 can utilize software, hardware, firmware, and/or logic to perform a number of functions. The machine 550 can be a combination of hardware and program instructions configured to perform a number of functions (e.g., actions). The hardware, for example, can include a number of processing resources 508 and a number of memory resources 510, such as a machine-readable medium (MRM) or other memory resources 510. The memory resources 510 can be internal and/or external to the machine 550 (e.g., the machine 550 can include internal memory resources and have access to external memory resources). In some embodiments, the machine 550 can be a virtual computing instance (VCI) or other computing device. The term “VCI” covers a range of computing functionality. The term “virtual machine” (VM) refers generally to an isolated user space instance, which can be executed within a virtualized environment. Other technologies aside from hardware virtualization can provide isolated user space instances, also referred to as data compute nodes. Data compute nodes may include non-virtualized physical hosts, VMs, containers that run on top of a host operating system without a hypervisor or separate operating system, and/or hypervisor kernel network interface modules, among others. Hypervisor kernel network interface modules are non-VM data compute nodes that include a network stack with a hypervisor kernel network interface and receive/transmit threads. The term “VCI” covers these examples and combinations of different types of data compute nodes, among others.

The program instructions (e.g., machine-readable instructions (MRI)) can include instructions stored on the MRM to implement a particular function (e.g., an action such as processing streams of change events). The set of MRI can be executable by one or more of the processing resources 508. The memory resources 510 can be coupled to the machine 550 in a wired and/or wireless manner. For example, the memory resources 510 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 510 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media.

The processing resources 508 can be coupled to the memory resources 510 via a communication path 552. The communication path 552 can be local or remote to the machine 550. Examples of a local communication path 552 can include an electronic bus internal to a machine, where the memory resources 510 are in communication with the processing resources 548 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 552 can be such that the memory resources 510 are remote from the processing resources 508, such as in a network connection between the memory resources 510 and the processing resources 508. That is, the communication path 552 can be a network connection. Examples of such a network connection can include a local area network (LAN), wide area network (WAN), personal area network (PAN), and the Internet, among others.

As shown in FIG. 5, the MRI stored in the memory resources 508 can be segmented into a number of modules 546, 548 that when executed by the processing resources 508 can perform a number of functions. As used herein a module includes a set of instructions included to perform a particular task or action. The number of modules 546, 548 can be sub-modules of other modules. For example, the replacement module 548 can be a sub-module of the expiry module 546 and/or can be contained within a single module. Furthermore, the number of modules 546, 548 can comprise individual modules separate and distinct from one another. Examples are not limited to the specific modules 546, 548 illustrated in FIG. 5.

One or more of the number of modules 546, 548 can include program instructions and/or a combination of hardware and program instructions that, when executed by a processing resource 508, can function as a corresponding engine as described with respect to FIG. 4. For example, the expiry module 546 can include program instructions and/or a combination of hardware and program instructions that, when executed by a processing resource 508, can function as the expiry engine 446.

For example, the machine 550 can include an expiry module 546, which can include instructions to receive an indication of an expiry of a first certificate of a virtual appliance in a virtualized environment via a certificate management agent of a gateway device in communication with the appliance. For example, the machine 550 can include a replacement module 548, which can include instructions to perform a certificate replacement process responsive to determining that the expiry of the first certificate exceeds a threshold. As described herein, a certificate replacement process can include sending a request to the appliance via an agent associated with the appliance. As described herein, a certificate replacement process can include receiving, from the appliance, a certificate signing request (CSR). As described herein, a certificate replacement process can include sending the CSR to an external certificate authority. As described herein, a certificate replacement process can include receiving a second certificate from the certificate authority. As described herein, a certificate replacement process can include replacing the first certificate with the second certificate.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving an indication of an expiry of a first certificate of a virtual appliance in a virtualized environment via a certificate management agent of a gateway device in communication with the appliance; and
performing a certificate replacement process responsive to determining that the expiry of the first certificate exceeds a threshold, wherein the certificate replacement process includes:
sending a request to the appliance via an agent associated with the appliance;
receiving, from the appliance, a certificate signing request (CSR);
sending the CSR to an external certificate authority;
receiving a second certificate from the certificate authority; and
replacing the first certificate with the second certificate.

2. The method of claim 1, wherein the method includes the agent associated with the appliance periodically polling an application programming interface (API) of the appliance to determine the expiry of the first certificate.

3. The method of claim 1, wherein the method includes receiving the indication of the expiry of the first certificate from the agent associated with the appliance via a certificate management agent associated with a gateway device.

4. The method of claim 1, wherein the method includes generating a public key and a private key by the appliance responsive to receiving the request via the agent associated with the appliance.

5. The method of claim 4, wherein the method includes preserving the private key by the appliance.

6. The method of claim 1, wherein the gateway device is not connected to an internet.

7. The method of claim 1, wherein replacing the first certificate with the second certificate includes sending the second certificate to the appliance.

8. A non-transitory machine-readable medium having instructions stored thereon which, when executed by a processor, cause the processor to:
receive an indication of an expiry of a first certificate of a virtual appliance in a virtualized environment via a certificate management agent of a gateway device in communication with the appliance; and
perform a certificate replacement process responsive to determining that the expiry of the first certificate exceeds a threshold, wherein the certificate replacement process includes:
sending a request to the appliance via an agent associated with the appliance;
receiving, from the appliance, a certificate signing request (CSR);
sending the CSR to an external certificate authority;
receiving a second certificate from the certificate authority; and
replacing the first certificate with the second certificate.

9. The medium of claim 8, including instructions to periodically poll, by the agent associated with the appliance, an application programming interface (API) of the appliance to determine the expiry of the first certificate.

10. The medium of claim 8, including instructions to receive the indication of the expiry of the first certificate from the agent associated with the appliance via a certificate management agent associated with a gateway device.

11. The medium of claim 8, including instructions to generate a public key and a private key by the appliance responsive to receiving the request via the agent associated with the appliance.

12. The medium of claim 11, including instructions to preserve the private key by the appliance.

13. The medium of claim 8, wherein the gateway device is not connected to an internet.

14. The medium of claim 8, wherein the instructions to replace the first certificate with the second certificate include instructions to send the second certificate to the appliance.

15. A system, comprising:
an expiry engine configured to receive an indication of an expiry of a first certificate of a virtual appliance in a virtualized environment via a certificate management agent of a gateway device in communication with the appliance; and
a replacement engine configured to perform a certificate replacement process responsive to determining that the expiry of the first certificate exceeds a threshold, wherein the certificate replacement process includes:
sending a request to the appliance via an agent associated with the appliance;
receiving, from the appliance, a certificate signing request (CSR);
sending the CSR to an external certificate authority;
receiving a second certificate from the certificate authority; and
replacing the first certificate with the second certificate.

16. The system of claim 15, wherein the agent associated with the appliance is configured to periodically poll an application programming interface (API) of the appliance to determine the expiry of the first certificate.

17. The system of claim 15, wherein an expiry agent is configured to receive the indication of the expiry of the first certificate from the agent associated with the appliance via a certificate management agent associated with a gateway device.

18. The system of claim 15, wherein the appliance is configured to generate a public key and a private key by the appliance responsive to receiving the request via the agent associated with the appliance.

19. The system of claim 18, wherein the appliance is configured to preserve the private key.

20. The system of claim 15, wherein the gateway device is not connected to an internet.
